(19) United States
(12) Patent Application Publication
(10) Pub. No.: US 2017/0097071 A1
(43) Pub. Date: Apr. 6, 2017

(54) STEERING COLUMN FOR A MOTOR VEHICLE, THREADED ROD AND SPINDLE NUT

(71) Applicants: ThyssenKrupp Presta AG, Eschen (LI); THYSSENKRUPP AG, Essen (DE)

(72) Inventor: Robert Galehr, Mauren (LI)

(73) Assignees: ThyssenKrupp Presta AG, Eschen (LI); ThyssenKrupp AG, Essen (DE)

(21) Appl. No.: 15/127,906

(22) PCT Filed: Mar. 18, 2015
(86) PCT No.: PCT/EP2015/055662

§ 371 Date: Sep. 21, 2016

(30) Foreign Application Priority Data
Mar. 21, 2014 (DE) 10 2014 103 879.7

(51) Int. Cl. F16H 25/20; B62D 1/185; B62D 1/187; B62D 1/181

(52) U.S. Cl. CPC F16H 25/20; B62D 1/181; B62D 1/185; B62D 1/187; F16H 2025/209; F16H 2025/2046; F16H 2025/2084

(57) ABSTRACT

The present invention relates to a steering column for a motor vehicle, comprising a support unit which is connectable to the chassis of the motor vehicle and comprising a positioning unit which is held on said support unit and which serves for the mounting of a steering spindle for transmitting a steering moment from a steering wheel to a steerable wheel, wherein the position of the positioning unit relative to the support unit is adjustable by way of an adjustment drive, wherein the adjustment drive comprises a threaded rod with an external thread which engages with an internal thread of a spindle nut of the adjustment drive, wherein the external thread of the threaded rod and/or the internal thread of the spindle nut comprises a flank angle (α) of between 35° and 55°.

### FIELD

The present invention relates to a steering column for a motor vehicle, which steering column comprises a support unit, which is connectable to the chassis of the motor vehicle, and a positioning unit, which is held on said support unit and which is adjustable relative to the support unit by way of an adjustment drive. The invention also relates to a threaded rod and to a spindle nut for a drive for the adjustment of a steering column of said type.

### BACKGROUND

Steering columns for motor vehicles which comprise a support unit, for example in the form of bracket parts, which is connectable to the chassis of the motor vehicle, and a positioning unit, which is held on said support unit and which is adjustable relative to said support unit, are known. The positioning unit serves for the mounting of a steering spindle which serves for the introduction of a steering movement from a steering wheel into a steering system for transmitting the steering movement to a steerable wheel.

It is known for a positioning unit of said type to be designed to be adjustable relative to the supporting unit by way of an adjustment drive for the purposes of being able to adapt the position of a steering wheel, which is held on the steering spindle, to the respective seating position of a driver of the motor vehicle. Here, it is known for adjustability of the positioning unit in an axial direction relative to the steering spindle to be provided in order to realize a longitudinal adjustment of the steering column. It is furthermore known for a vertical adjustment of the steering wheel to be made possible by way of pivoting of the positioning unit relative to the support unit.

Known adjustment drives comprise electric motors by means of which a convenient adjustment of the positioning unit relative to the support unit can be realized and which also make it possible for previously stored positions to be repeatedly reassumed, in particular if multiple drivers operate the motor vehicle.

In the case of electrically adjustable steering columns for motor vehicles, it is necessary for the rotation of a drive output shaft of an electric motor to be converted into a translational adjustment movement for the adjustment of the positioning unit relative to the support unit. This is normally realized by way of a threaded-rod drive which comprises a worm shaft, arranged on the drive output of the electric motor, and a spindle nut, which on its outer side is in the form of a worm wheel, the toothing of which is engaged into by the worm shaft arranged on the drive output shaft of the electric motor. By rotation of the positionally fixed spindle nut, the threaded rod is moved axially.

AT 511962 A4 has disclosed a steering column for a motor vehicle, in the case of which both a displacement of the steering spindle and a pivoting of the steering spindle relative to a support unit can be performed in order to realize corresponding positioning of the steering wheel that is held on the steering spindle. Adjustment movements, that is to say both the displacement and the pivoting, are realized by way of in each case one spindle drive. The spindle drives comprise in each case one threaded rod which is held, by way of a spindle nut, on one of the two units that are adjustable relative to one another. The spindle nut is mounted in positionally fixed fashion and can be rotated by way of a drive motor with a worm shaft which acts on an external toothing of the spindle nut, in order, by way of an internal thread which engages with the threaded rod, to correspondingly realize a translational movement of the threaded rod relative to the spindle nut in the direction of the threaded spindle axis. By way of the translational movement of the threaded rod, the adjustment movement of the positioning unit is realized.

It is known, for the external thread of the threaded rod and for the internal thread of the spindle nut, to use a metric ISO standard thread which comprises a flank angle of 60°. DE 36 36 315 A1 has disclosed an axially adjustable steering column for a motor vehicle, in the case of which a thread of said type is presented for the external thread of the threaded rod.

In the case of an ISO standard thread being used, it is the case, owing to the relatively shallow flank angle of 60°, that high forces are introduced into the thread flanks, which forces can lead to spreading of the spindle nut or compression of the threaded rod, and can thereby adversely influence the drive characteristics of the adjustment drive.

Furthermore, it is known for example from EP 2 412 607 A2 for the thread of an adjustment drive to be in the form of a trapezoidal thread, for example an ISO trapezoidal thread, which comprises a flank angle of 30°.

In the case of an ISO trapezoidal thread being used, it is considered to be disadvantageous that the respective thread flights comprise a large flight thickness, giving rise to a relatively large external diameter of the respective assembly.

### SUMMARY

Taking the known prior art as a starting point, it is an object of the present invention to specify a steering column for a motor vehicle having an adjustment drive, and a threaded rod and a spindle nut for an adjustment drive, which provide improved drive characteristics of the adjustment drive.

Said object is achieved by way of a steering column for a motor vehicle having the features of claim 1. Advantageous refinements emerge from the subclaims.

Correspondingly, a steering column for a motor vehicle is proposed, comprising a support unit which is connectable to the chassis of the motor vehicle and comprising a positioning unit which is held on said support unit and which serves for the mounting of a steering spindle for transmitting a steering moment from a steering wheel to a steerable wheel, wherein the position of the positioning unit relative to the support unit is adjustable by way of an adjustment drive, wherein the adjustment drive comprises a threaded rod with an external thread which engages with an internal thread of a spindle nut of the adjustment drive. According to the invention, the external thread of the threaded rod and/or the internal thread of the spindle nut comprises a flank angle of between 35° and 55°.

The steering spindle can preferably transmit the steering movement from the steering wheel via a steering gear to the steerable wheel, in particular with the use of power assistance.

It is however also possible for the steering movement of the steering spindle to be detected by sensor means, for example electrically, electronically or magnetically, and for the detected signals to be fed into a controller which, by way of a device, performs a pivoting movement of the steerable wheel in order to replicate the steering movement. Such systems are known as steer-by-wire systems.

By virtue of the fact that the external thread of the threaded rod and/or the internal thread of the spindle nut comprises a flank angle of 35° to 55°, it is possible for spreading of the spindle nut during operation to be reduced or prevented entirely, such that the drive behavior of the adjustment drive can be correspondingly improved.

Furthermore, in this way, it is possible to realize as small as possible a thread nominal diameter with a large thread core diameter, because, owing to the reduced or entirely absent spreading of the spindle nut, it is possible for the forces required for the adjustment to be transmitted even with a small flank height of the thread. In this way, too, the operating characteristics of the adjustment drive can be improved, because deformations in the material of the threaded rod and/or of the spindle nut can be reduced or prevented entirely. In this way, reliable operation of an electrically adjustable steering column can be realized by way of the adjustment drive. Furthermore, the background noise can be reduced in this way.

The flank angle preferably lies between 40° and 50° in order that the force components that spread the spindle nut are kept as low as possible but, at the same time, simple production of the respective thread is made possible, for example by cutting.

Correspondingly, the external thread and/or the internal thread is preferably in the form of a cut thread. Owing to the possibility of cutting the thread, it is possible to resort to different materials for the threaded rod and the spindle nut. Such a relatively free material selection makes it possible for the external thread of the threaded rod and/or the internal thread of the spindle nut to be cut into a plastics material, for example also into a plastics material which comprises a fiber reinforcement.

The flank angle from 35° to 55° therefore makes it possible, owing to the relatively low spreading tendency, to furthermore produce the spindle nut entirely from a plastics material, in order to thereby realize improved operating characteristics of the adjustment drive, in particular with regard to its vibration and/or oscillation characteristics and with regard to the long-term tribological characteristics.

Alternatively, and preferably, the thread is directly injection-molded or molded during the forming of the spindle. The same also applies to the spindle nut.

The external thread and/or the internal thread preferably comprises at least two thread flights. Here, formation of a thread with exactly two flights is particularly preferred. However, threads formed with exactly three flights or exactly four flights may also be advantageous. By way of the embodiment as a multi-flight thread, it is possible to realize more efficient, faster and more reliable positioning of the positioning unit. However, the motor power must be adapted to the correspondingly faster adjustment speed.

Simple producibility and operating characteristics of the adjustment drive which are neutral in terms of direction of rotation are preferably realized if the external thread and/or the internal thread is of flank-centered design.

The vibration characteristics, the tribological characteristics and/or the damping characteristics of the adjustment drive can be set advantageously if the threaded rod and the spindle nut comprise mutually different materials and are preferably composed entirely of mutually different materials.

In this context, in a preferred embodiment, the spindle nut and/or the threaded rod comprises a plastics material or is preferably manufactured entirely from a plastics material, particularly preferably from a plastics material which comprises a fiber reinforcement. Here, the fiber reinforcement may also be formed only in the center of the threaded spindle in order to ensure a high level of rigidity in the transmission but to simultaneously ensure easy formation of the thread without the fibers being broken up in the process and thus the tribological characteristics being impaired. In particular, use may be made of glass fibers, carbon fibers or aramide fibers.

The above-described object is furthermore achieved by way of a threaded rod having the features of claim 8.

Correspondingly, a threaded rod for an adjustment drive for the adjustment of the position of a positioning unit relative to a support unit of a steering column for a motor vehicle is proposed, comprising an external thread for engaging into an internal thread of a spindle nut. According to the invention, the external thread comprises a flank angle of between 35° and 55°. In a preferred refinement, the flank angle lies between 40° and 50°.

The above-described object is furthermore achieved by way of a spindle nut having the features of claim 9.

Correspondingly, a spindle nut for an adjustment drive for the adjustment of the position of a positioning unit relative to a support unit of a steering column for a motor vehicle is proposed, comprising an internal thread for engaging into an external thread of a threaded rod.

According to the invention, the internal thread comprises a flank angle of between 35° and 55°. In a preferred refinement, the flank angle lies between 40° and 50°.

The threaded rod and the spindle nut may preferably also be refined by way of the features of the subclaims that are dependent on claim 1.

### BRIEF DESCRIPTION OF THE FIGURES

Preferred further embodiments and aspects of the present invention will be discussed in more detail on the basis of the following description of the figures, in which:

FIG. 1 is a schematic perspective illustration of a steering column having an electrical adjustment means;

FIG. 2 shows the steering column from FIG. 1 in a schematic side view;

FIG. 3 shows the steering column from FIG. 1 in a further schematic side view;

FIG. 4 shows an adjustment drive for a steering column as per the abovementioned figures in an exploded illustration;

FIG. 5 is a schematic sectional illustration through a threaded rod and a spindle nut of an adjustment drive; and

FIG. 6 shows a detail view of a section of the adjustment drive from FIG. 5.

### DETAILED DESCRIPTION

Below, preferred exemplary embodiments will be described on the basis of the figures. Here, identical elements, similar elements or elements of identical action are denoted by the same reference designations in the various figures, and in order to avoid redundancies, a repeated description of said elements will, in part, be omitted in the following description.

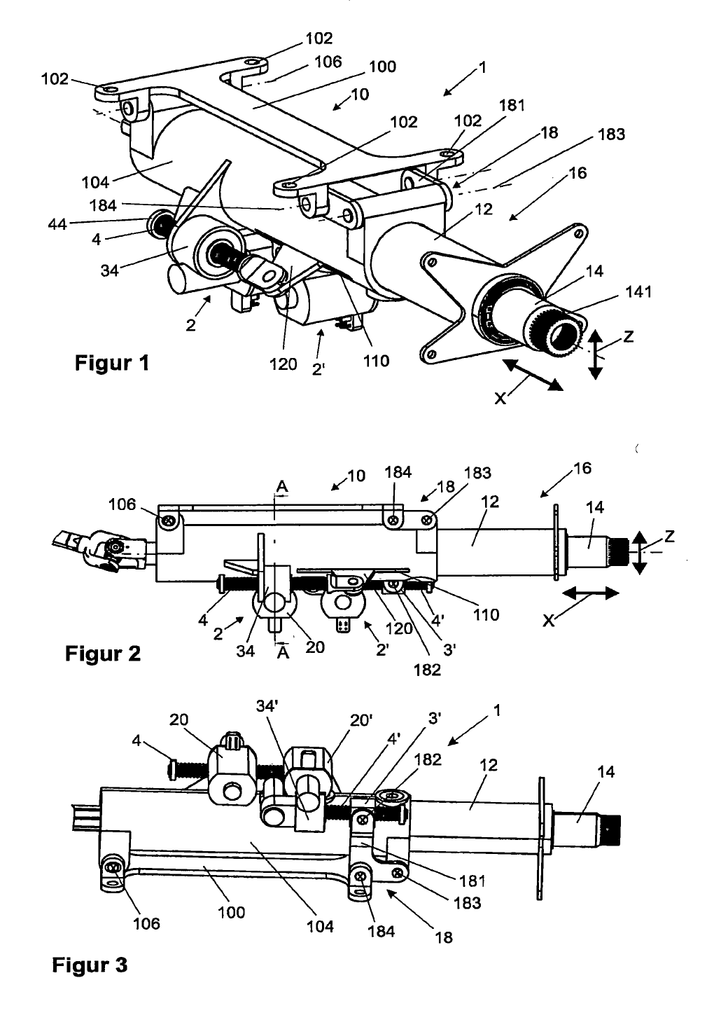

FIG. 1 shows a steering column 1 which comprises a support unit 10 which is connectable to the chassis of a motor vehicle (not shown here), on which support unit a positioning unit 16 is held in adjustable fashion. The support unit 10 comprises a bracket 100 which can be fastened to the chassis of the motor vehicle, for example by way of fastening bores 102.

The positioning unit 16 comprises a casing tube 12 in which a steering spindle 14 is rotatably mounted. A steering wheel (not shown here) can be fastened to the steering wheel-side end 141 of the steering spindle 14. The steering spindle 14 serves for transmitting a steering moment, which is introduced into the steering spindle 14 by a driver via the steering wheel, to a steerable wheel (not shown here) in a known manner. Here, the steering spindle 14 can transmit steering movement from the steering wheel to the steerable wheel via a steering gear, if appropriate with the aid of power assistance.

In one variant, it may also be provided that the steering movement of the steering spindle 14 is detected by sensor means, for example electrically, electronically or magnetically, and the detected signals are fed into a controller which, by way of a steering device, performs a pivoting movement of the steerable wheel in order to replicate the steering movement. Such systems are known as steer-by-wire systems.

The casing tube 12 is held, so as to be displaceable in a longitudinal adjustment direction X, in a support tube 104, wherein the longitudinal adjustment direction X extends in an axial direction of the steering spindle 14. By way of an adjustment of the casing tube 12 relative to the support tube 104, it is correspondingly possible to realize a longitudinal adjustment of the steering spindle 14 and thus of the steering wheel (not illustrated) for the purposes of adapting the position of the steering wheel to the seating position of a driver of the motor vehicle.

The support tube 104 is pivotably fastened to the bracket 100 and can be pivoted relative to the bracket 100 about a pivot axis 106. Adjustability of the positioning unit 16 in a vertical adjustment direction Z, which is oriented substantially perpendicular to the longitudinal adjustment X, is made possible by virtue of the fact that the casing tube 12 is held on the bracket 100 by way of a pivoting mechanism 18. This yields pivotability of the casing tube 12 and of the steering spindle 14 relative to the support unit 10 and in particular relative to the bracket 100 about the pivot axis 106 such that a vertical adjustment of the steering wheel (not shown here) which is arranged on the steering spindle 14 is also realized, in order, in this way, to realize an adaptation of the position of the steering wheel to the seating position of the driver.

In the exemplary embodiment, there is, for each of the two adjustment directions, a separate adjustment drive 2, 2′ with in each case one separate adjustment mechanism, comprising a threaded rod 4, 4′ and a spindle nut 3.

An adjustment drive 2 is provided by way of which an adjustment of the positioning unit 16 relative to the support unit 10 in the longitudinal adjustment direction X can be realized. The adjustment drive 2 comprises a threaded rod 4 which is connected by way of an articulation lever 120 to the casing tube 12. The articulation lever 120 is guided displaceably in a slot 110 in the support tube 104 such that a displacement of the articulation lever 120 relative to the support tube 104 leads to a displacement of the positioning unit 16 relative to the support unit 10.

The threaded rod 4 is held on the articulation lever 120 and extends in the longitudinal adjustment direction X. The threaded rod 4 is also held in a spindle nut 3 which comprises an internal thread 32 which is in engagement with the external thread of the threaded rod 4. The spindle nut 3 is mounted rotatably but positionally fixedly relative to the carrier tube 104 in a mechanism housing 34, such that a rotation of the spindle nut 3 leads, owing to the thread engagement with the threaded rod 4, to an axial movement of the threaded rod relative to the spindle nut 3. In other words, a rotation of the spindle nut 3 gives rise to a relative movement between casing tube 12 and support tube 104 such that an adjustment of the position of the positioning unit 16 relative to the support unit 10 is effected by the rotation of the spindle nut 3.

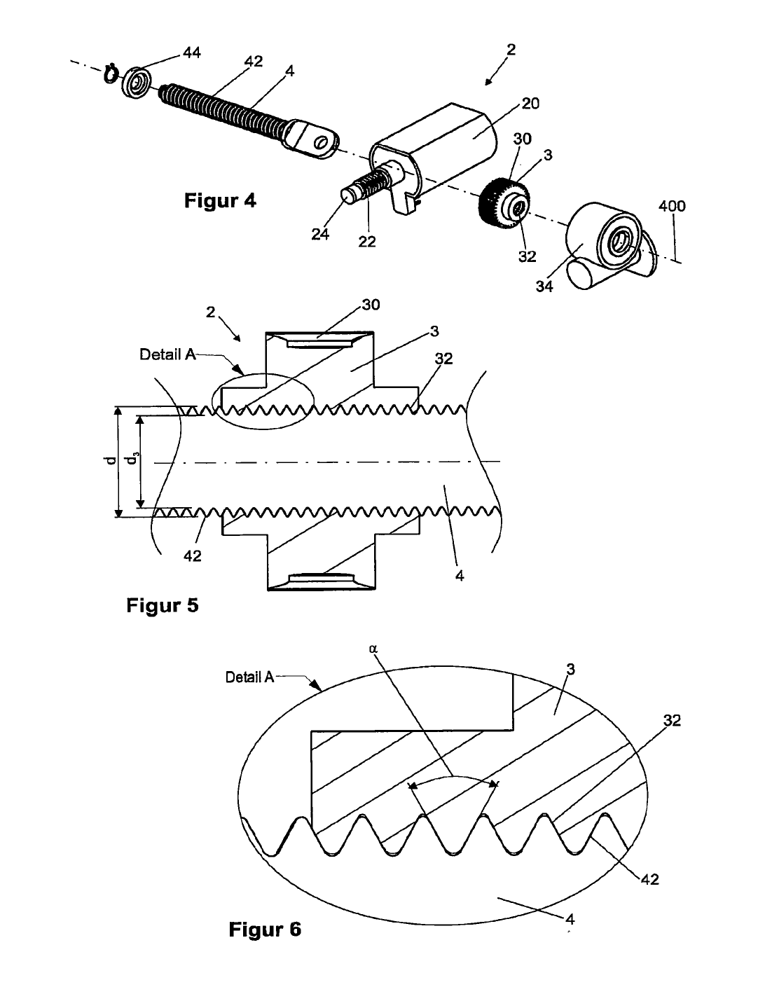

The adjustment drive 2 furthermore comprises a drive motor 20, on the drive output shaft 24 of which there is arranged a worm shaft 22 which can be clearly seen in FIG. 4. The worm shaft 22 engages into an external toothing 30 of the spindle nut 3, wherein the external toothing 30 is in the form of a worm wheel. The axis of rotation of the worm shaft 22 and the axis of rotation of the spindle nut 3 are perpendicular to one another, as is known per se in the case of a worm mechanism.

Correspondingly, by way of a rotation of the drive output shaft 24 of the drive motor 20, the spindle nut 3 can be rotated, whereby a longitudinal adjustment of the positioning unit 16 relative to the support tube 104 in the longitudinal adjustment direction X, and thus a displacement of the positioning unit 16 relative to the support unit 10, are realized.

A corresponding adjustment drive 2′ can be seen particularly clearly in FIG. 3.

Said further adjustment drive 2′ comprises, in principle, the same construction as the first adjustment drive 2. The further adjustment drive 2′ drives an adjustment movement of the positioning unit 16 in the vertical adjustment direction Z. By way of the rotation of a threaded rod 4′, a spindle nut 3′ is displaced in an axial direction. The spindle nut 3′ is connected by way of a joint 182 to a positioning lever 181. The positioning lever 181 is held, pivotably about a joint axis 183, on the support tube 104 and, pivotably about a joint axis 184, on the bracket 100. It is achieved in this way that, by way of the threaded rod 4′, the spindle nut 3′ imparts a corresponding adjustment to the pivoting mechanism 18 and thus to the positioning unit 16 and the support tube 104. For a required length compensation, a corresponding compensation function is integrated in one of the joints. In the example, this is realized by way of a slotted receptacle of a bolt, which forms the pivot axis 106, in the bracket.

FIG. 4 shows the adjustment drive 2 once again in a schematic, perspective and exploded view. The drive motor 20 with the drive output shaft 24, on which the worm shaft 22 is formed, can be seen. The worm shaft 22 engages with the external toothing 30, in the form of a worm wheel, of the spindle nut 3. The spindle nut 3 is held in the mechanism housing 34 so as to be positionally fixed and so as to be rotatable about the axis 400 of the threaded rod 4. The spindle nut 3 is in this case mounted so as to be non-displaceable relative to the support tube 104 in the direction of the axis 400 of the threaded rod 4. The threaded rod 4 is, by way of its external thread 42, in engagement with the internal thread 32 of the spindle nut 3. The mechanism housing 34 correspondingly ensures that, by way of a rotation of the spindle nut 3, the threaded rod 4, which is in engagement with said spindle nut, can be displaced in the direction of the axis 400 of the threaded rod 4.

The spindle nut 3 and/or the threaded rod 4 may preferably comprise, or be composed entirely of, a non-fiber-reinforced plastic such as for example POM (polyoxymethylene), POM homopolymers, DELRIN© 100 NC 010 and/or DELRIN© 100 AL NC 010. The spindle nut 3 and/or the threaded rod 4 may preferably also comprise a fiber-reinforced plastic or be composed entirely of a fiber-reinforced plastic, for example POM with carbon fibers and/or PBT (polybutylene terephthalate) with carbon fibers.

It is particularly preferable for the plastics material to comprise lubricating agents added thereto in order to permit self-lubrication of the internal thread 32 of the spindle nut 3 with the external thread 42 of the threaded rod 4, such that particularly low-friction and low-noise operation is made possible, and the tribological characteristics are kept substantially constant over the service life of the drive 2.

FIGS. 5 and 6 show a section of the adjustment drive 2 in which it is possible to see in particular the threaded rod 4 and the spindle nut 3. As already stated, the threaded rod 4 comprises an external thread 42. In the exemplary embodiment shown, the external thread 42 is of single-flight form.

The spindle nut 3 comprises an internal thread 32 which is complementary to the external thread 42 of the threaded rod 4, which internal thread is in engagement with the external thread 42 of the threaded rod 4.

As can be seen from the detail illustration in FIG. 6, the flank angle α of the external thread 42 of the threaded rod 4 is relatively small, and in the exemplary embodiment shown, is slightly less than 55°.

The preferred angle range for the flank angle α lies between 35° and 55°. In this way, in the event of a rotation of the spindle nut 3 about the threaded rod 4, the force component which spreads the spindle nut 3 can be reduced in relation to the thread forms known from the prior art. In this way, the operating characteristics of the adjustment drive 2 are improved in relation to the solutions known from the prior art.

It is furthermore possible for the spindle nut 3 to be produced from materials other than the materials known from the prior art. In particular, the spindle nut 3 may also be produced from a plastics material which may comprise improved tribological characteristics, damping characteristics and vibration characteristics in relation to the conventional materials, such that the operating characteristics of the adjustment drive 2 can be further improved.

The external thread 42 of the threaded rod 4 may be cut into the material of the threaded rod 4. This has the effect that the external thread 42 can be formed easily into a wide variety of materials, such that correspondingly greater freedom in terms of material selection is obtained.

By way of the selected flank angle α, the production of relatively fine thread turns is also made possible, such that easier producibility both of the threaded rod 4 and of the spindle nut 3 can be realized.

It is also particularly preferable for the external thread 42 of the threaded rod 4 to be cut into a plastics material, and either for the threaded rod 4 to correspondingly be produced entirely from a plastics material, or for a plastics material to encase a spindle composed of a different material—for example a metal—in order to form the external thread 42.

The internal thread 32 of the spindle nut 3 preferably comprises a geometry complementary to the external thread 42 of the threaded rod 4. Correspondingly, in the exemplary embodiment shown, it is also the case that the internal thread 32 of the spindle nut 3 comprises a flank angle α of slightly less than 55°. Here, as is the case for the external thread 42 of the threaded rod 4, the preferred range for the flank angle lies between 35° and 55°, particularly preferably between 40° and 50°.

The nominal diameter d of the threaded rod 4 can be reduced by way of the selection of the stated flank angle α which lies between 35° and 55°, particularly preferably between 40° and 50°. In particular, it is also possible for the core diameter d₃ to be increased because, owing to the relatively steep flanks, a better transmission of force takes place, and a deformation of the spindle nut 3 or spreading of the spindle nut 3 is reduced in relation to the thread geometries known from the prior art. Correspondingly, the same force can be transmitted by way of a thread flight which comprises a smaller height than the thread flights that are known from the prior art. In this way, the core diameter d₃ can be relatively increased in relation to a conventional geometry known from the prior art, such that either the entire threaded rod 4 can be reduced in terms of its nominal diameter d, or the stability is increased for a given nominal diameter d.

Use is particularly preferably made of a flank-centered thread as shown in FIG. 5 and FIG. 6 in order to realize the easiest possible machinability and production of the internal thread 32 of the spindle nut 3 and of the external thread 42 of the threaded rod 4. Furthermore, by way of a correspondingly flank-centered thread, it is possible to realize identical drive behavior during the adjustment of the adjustment drive 2 in both directions of rotation of the spindle nut 3.

Where applicable, all individual features presented in the individual exemplary embodiments may be combined with one another and/or exchanged for one another without departing from the scope of the invention.

### LIST OF REFERENCE DESIGNATIONS

1 Steering column
10 Support unit
12 Casing tube
14 Steering spindle
141 Steering wheel-side end
16 Positioning unit
18 Pivoting mechanism
100 Bracket
102 Fastening bore
104 Support tube
106 Pivot axis
110 Slot
120 Articulation lever
181 Positioning lever
182 Joint
183 Joint axis
184 Joint axis
2 Adjustment drive
2′ Adjustment drive
20 Drive motor
20′ Drive motor
22 Worm shaft
24 Drive output shaft
3 Spindle nut
30 External toothing
32 Internal thread
34 Mechanism housing
34′ Mechanism housing
4 Threaded rod
4′ Threaded rod
42 External thread
44 Stop
400 Axis of the threaded rod
α Angle
X Longitudinal adjustment direction
Z Vertical adjustment direction
d Nominal diameter
d₃ core diameter

1. A steering column for a motor vehicle, the steering column comprising:
a support unit which is connectable to the chassis of the motor vehicle: a positioning unit which is held on said support unit and which serves for the mounting of a steering spindle for transmitting a steering moment from a steering wheel to a steerable wheel, wherein the position of the positioning unit relative to the support unit is adjustable by way of an adjustment drive, wherein the adjustment drive comprises a threaded rod with an external thread which engages with an internal thread of a spindle nut of the adjustment drive, and
wherein at least one of the external thread of the threaded rod and the internal thread of the spindle nut comprises a flank angle (α) of between 35° and 55°.

2. The steering column as claimed in claim 1 wherein the flank angle (α) lies between 40° and 50°.

3. The steering column as claimed in claim 1 wherein at least one of the external thread and the internal thread comprises at least two thread flights.

4. The steering column of claim 3 wherein at least one of the external thread and the internal thread is of flank-centered design.

5. The steering column of claim 3 wherein at least one of the external thread and the internal thread is in the form of a cut thread.

6. The steering column of claim 1 wherein the threaded rod and the spindle nut comprise mutually different materials and are composed entirely of different materials.

7. The steering column of claim 1 wherein at least one of the spindle nut and the threaded rod comprises a plastics material.

8. The steering column as claimed in claim 7 wherein the spindle nut is formed from a plastics material which comprises a fiber reinforcement.

9. A threaded rod for an adjustment drive of a steering column, comprising an external thread for engaging into an internal thread of a spindle nut wherein the external thread comprises a flank angle (α) of between 35° and 55°.

10. A spindle nut for an adjustment drive ) of a steering column, comprising an internal thread for engaging into an external thread of a threaded wherein the internal thread comprises a flank angle (α) of between 35° and 55°.
